(19) United States
(12) Patent Application Publication
(10) Pub. No.: US 2007/0077936 A1
(43) Pub. Date: Apr. 5, 2007

(54) Wireless base station and wireless communication system

(75) Inventors: Toshiaki Tomisawa, Tokyo (JP); Hiroshi Nagai, Tokyo (JP); Toshihiko Shirokura, Tokyo (JP)

Correspondence Address: BIRCH STEWART KOLASCH & BIRCH, PO BOX 747, FALLS CHURCH, VA, 22040-0747, US

(73) Assignee: MITSUBISHI DENKI KABUSHIKI KAISHA, Tokyo (JP)

(21) Appl. No.: 10/571,923

(22) PCT Filed: Jun. 29, 2004
(86) PCT No.: PCT/JP04/09500

§ 371 Date: Mar. 15, 2006

(51) Int. Cl. H04Q 7/20

(52) U.S. Cl. 455/450

(57) ABSTRACT

A setting unit sets a specified time serving as a clear-to-send time, during which a two-way frame transmission is possible between a local wireless base station and a wireless terminal station accommodated in the wireless base station, and as a wireless-channel reservation time used for a frame transmission between the wireless base station and the wireless terminal station, and wireless terminal station specifying information for specifying a wireless terminal station to which the specified time is applied, in a transmission control frame. A transmitting unit transmits the transmission control frame to the wireless terminal station.

### TECHNICAL FIELD

The present invention relates to a wireless communication system conforming to the IEEE 802.11a, b, and g, including a wireless base station and a plurality of wireless terminal stations accommodated in the wireless base station, and a wireless base station used for the wireless communication system. More specifically, the invention relates to a wireless communication system and a wireless base station, which prevent frame collisions under a condition that a Distributed Coordination Function (DCF) is adopted and control traffic between wireless terminal stations, thereby realizing excellent wireless communications.

### BACKGROUND ART

Conventionally, as an access method specified in the IEEE 802.11 in a wireless LAN system, the Distributed Coordination Function (DCF) method as the essential function and a Point Coordination Function (PCF) method as an optional function are defined.

The DCF method uses Carrier Sense Multiple Access with Collision Avoidance (CSMA/CA). In the DCF method, respective wireless terminal stations scan wireless channels, and when the respective wireless terminal stations recognize that the wireless is idle, transmission is possible, and a channel can be commonly shared by terminals. In this case, however, a collision of data frames occurs.

In the DCF method, the following two methods are defined as a method of scanning the wireless channels. The first method is an access method according to Physical Carrier Sense (PCS) control, having a function of actually scanning a wireless area to determine whether another apparatus is transmitting radio waves, wherein radio waves are transmitted only when the wireless area is idle.

The second method is an access method according to Virtual Carrier Sense (VCS) control. With this method, a reservation time (μs) for a particular wireless terminal station is set in a header of a wireless frame (in a Duration/ID field in a media access control (MAC) header), and the frame is transmitted to all apparatuses in the wireless area (cell), to notify reservation of the wireless resource. The transmitter having transmitted the wireless frame in which the reservation time is set and wireless terminal stations other than the particular wireless terminal station set a parameter “Network Allocation Vector” (NAV) that holds the reservation time for the wireless area reserved by another wireless terminal station, so that frame transmission is not performed during the reservation time set in the header of the wireless frame. When the set “NAV” value is other than 0, it is determined that the wireless area is “busy”, and frame transmission is not performed.

On the other hand, in the PCF method, which is an option of the access method, since integrated control by polling from the wireless base station is possible, frame collisions between terminals can be avoided. However, in the IEEE 802.11, since the integrated control is an optional function, it is not always installed in all wireless base stations and terminals.

In the conventional technique, as a method of solving a problem in that frame collisions occur in the wireless, there is one in which the wireless base station monitors the situation of a reservation mini-slot, and notifies the wireless terminal station of the result (success, idle, collision). There is disclosed a technique in which the wireless terminal station sets a queue level of the own apparatus based on the presence of data to be transmitted and the result of the reservation mini-slot notified from the wireless base station, and controls data transmission based on the queue level of the own apparatus, thereby distributing the slot to be used for each wireless terminal station when a collision occurs, to avoid a frame collision (see, for example, Patent document 1).

In addition, a method in which when a state that an average data frame size exceeds a certain value continues for a certain time period, or when a state that a percentage of transmission data to be accumulated exceeds a certain value continues, the access method is switched from the DCF method to the PCF method is disclosed (see, for example, Patent document 2).

[Patent document 1] Japanese Patent Application Laid-open No. H11-289340

[Patent document 2] Japanese Patent Application Laid-open No. 2003-198564

In the DCF method, which is the essential access method in the IEEE 802.11, when a plurality of wireless base stations and wireless terminal stations starts frame transmission at the same timing, the frame is destroyed due to the occurrence of a frame collision. When the wireless base stations are arranged in a high density, or when the terminals are overcrowded, the probability of the occurrence of this phenomenon increases, thereby causing a problem in that the throughput in the whole network decreases.

On the other hand, in the PCF method defined as an option in the IEEE 802.11, since integrated control by polling is possible in the wireless base station, frame collisions between terminals can be avoided. However, since not all the wireless base stations and the terminals support the PCF method, when there is a terminal which only supports the PCF method, the same problem as in the DCF method occurs.

In Patent document 1, while a collision prevention method after a collision has occurred is disclosed, the occurrence of frame collisions cannot be reduced when frame transmission is started at the same timing, which is the basic problem.

In Patent document 2, since the access method is switched to the PCF method under a certain condition, frame collisions between terminals can be avoided under a condition that the PCF method is supported. However, the same problem as in the PCF method will occur, unless all the wireless base stations and wireless terminal stations support the PCF method.

In view of the above problems, it is an object of the present invention to provide a wireless base station and a wireless communication system that realize excellent wireless communication with frame collisions being prevented and traffic between wireless terminal stations being controlled.

### DISCLOSURE OF INVENTION

A wireless base station according to one aspect of the present invention, which employs a distributed coordination function, includes a setting unit that sets a specified time serving as a clear-to-send time, during which a two-way frame transmission is possible between a local wireless base station and a wireless terminal station accommodated in the wireless base station, and as a wireless-channel reservation time used for a frame transmission between the wireless base station and the wireless terminal station, and wireless terminal station specifying information for specifying a wireless terminal station to which the specified time is applied, in a transmission control frame for controlling timing of the frame transmission in the wireless terminal station; and a transmitting unit that transmits the transmission control frame to the wireless terminal station.

A wireless communication system according to another aspect of the present invention includes a wireless base station employing a distributed coordination function; and a plurality of wireless terminal stations accommodated in the wireless base station. The wireless base station transmits a transmission control frame for controlling timing of frame transmission in the wireless terminal stations. A specified time serving as a clear-to-send time, during which a two-way frame transmission is possible between a local wireless base station and a wireless terminal station accommodated in the wireless base station, and as a wireless-channel reservation time used for a frame transmission between the wireless base station and the wireless terminal station, and wireless terminal station specifying information for specifying a wireless terminal station to which the specified time is applied is set in the transmission control frame. When a local wireless terminal station is a target for applying the specified time, the local wireless terminal station can transmit a frame to the wireless base station, and when the local wireless terminal station is not the target for applying the specified time, the local wireless terminal station suspends a transmission of the frame to the wireless base station.

According to the present invention, a transmission allowable time serving as clear-to-send time, during which two-way transmission of the frame is possible between the wireless base station and the wireless terminal station, as well as a reservation time for a wireless channel used for the frame transmission between the wireless base station and the wireless terminal station is transmitted to the wireless terminal station at all times.

During the transmission allowable time, only a particular wireless terminal station can transmit a data frame to the wireless base station, and other wireless terminal stations cannot transmit a data frame at the same timing. Furthermore, since the wireless base station controls frame transmission in the wireless communication system at all times by using a transmission control frame, the frame transmission can be controlled not temporarily but at all times.

Accordingly, frame transmission between the wireless terminal stations can be controlled, and frame collisions between the wireless terminal stations can be prevented reliably. According to the present invention, therefore, in the wireless communication system in conformity with the IEEE 802.11a, b, and g, prevention of frame collisions and traffic control between the wireless terminal stations are realized, thereby realizing highly reliable wireless communications.

### BRIEF DESCRIPTION OF DRAWINGS

FIG. 1 depicts the configuration of a wireless communication system according to a first embodiment of the present invention;

FIG. 2 is an example of access control between wireless base stations in the wireless communication system according to the first embodiment;

FIG. 3 is a configuration diagram of one example of the MAC header configuration in a MAC frame defined in the IEEE 802.11 standard;

FIG. 4 is an example of a transmission allowable time;

FIG. 5 is another example of the transmission allowable time;

FIG. 6 is an example of access control between the wireless base station and a wireless terminal station when the traffic volume of the respective wireless terminal stations is evenly controlled in a second embodiment of the present invention;

FIG. 7 is an example of access control between the wireless base station and the wireless terminal station in a third embodiment of the present invention;

FIG. 8 depicts the configuration of the wireless communication system according to a fourth embodiment of the present invention;

FIG. 9 is an example of access control between the wireless base station and the wireless terminal station in the fourth embodiment;

FIG. 10 is an example of access control between the wireless base stations in a fifth embodiment of the present invention, focusing on a transfer operation of the transmission initiative of a transmission control frame; and

FIG. 11 is an example of access control between the wireless base stations in a sixth embodiment of the present invention, focusing on a transfer operation of the transmission initiative of a transmission control frame.

### BEST MODE(S) FOR CARRYING OUT THE INVENTION

Exemplary embodiments of a wireless base station and a wireless communication system according to the present invention will be explained below in detail with reference to the accompanying drawings. Note that the invention is not limited by the embodiments, and the embodiments can be arbitrarily modified without departing from the spirit of the invention.

First Embodiment

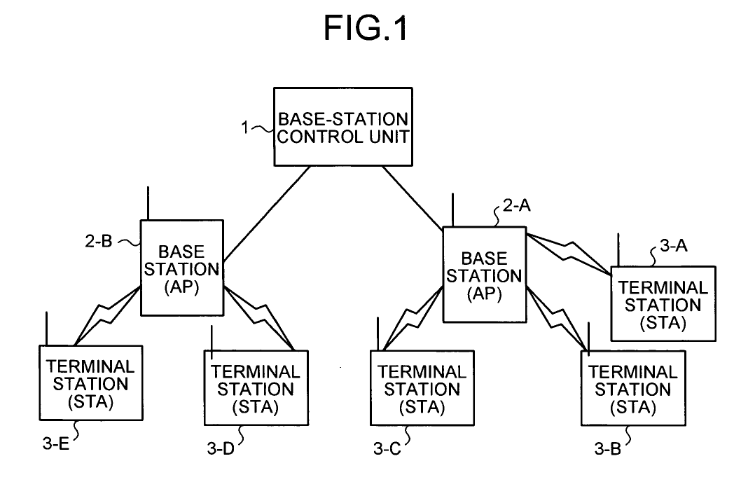

FIG. 1 depicts the configuration of a wireless communication system according to a first embodiment of the present invention. As shown in FIG. 1, the wireless communication system according to the first embodiment is a wireless LAN system in conformity with the IEEE 802.11a, b, and g, including a wireless base-station control unit 1, wireless base stations (AP) 2-A, 2-B (hereinafter, also referred to as wireless base station (AP) 2), and wireless terminal stations (STA) 3-A, 3-B, 3-C, 3-D, and 3-E (hereinafter, also referred to as wireless terminal station (STA) 3). The wireless communication system adopts the Distributed Coordination Function (DCF) method and the Virtual Carrier Sense (VCS) control method.

In the wireless communication system, a beacon frame having predetermined information for synchronizing the wireless terminal station (STA) 3 with the wireless base station (AP) 2 is transmitted periodically. The wireless terminal station (STA) 3 having received the beacon frame requests authentication with respect to the wireless base station (AP) 2. The wireless base station (AP) 2 having received the authentication request gives authentication and permission to the wireless terminal station (STA) 3. Accordingly, attribution process of the wireless terminal station (STA) 3 to the wireless base station (AP) 2 is completed. The wireless terminal station (STA) 3 can perform wireless communication with other wireless terminal stations (STA) 3 via the wireless base station (AP) 2.

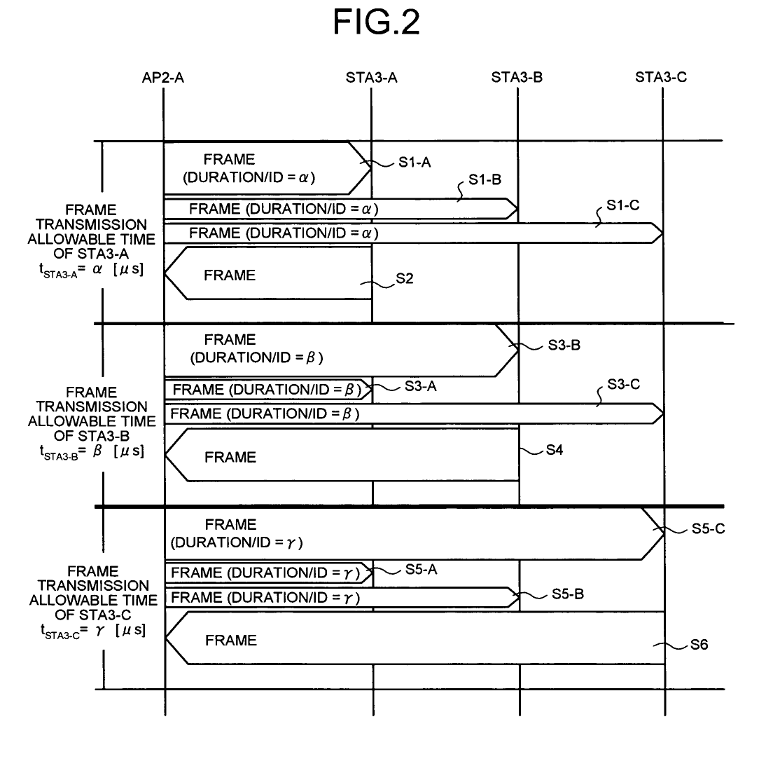

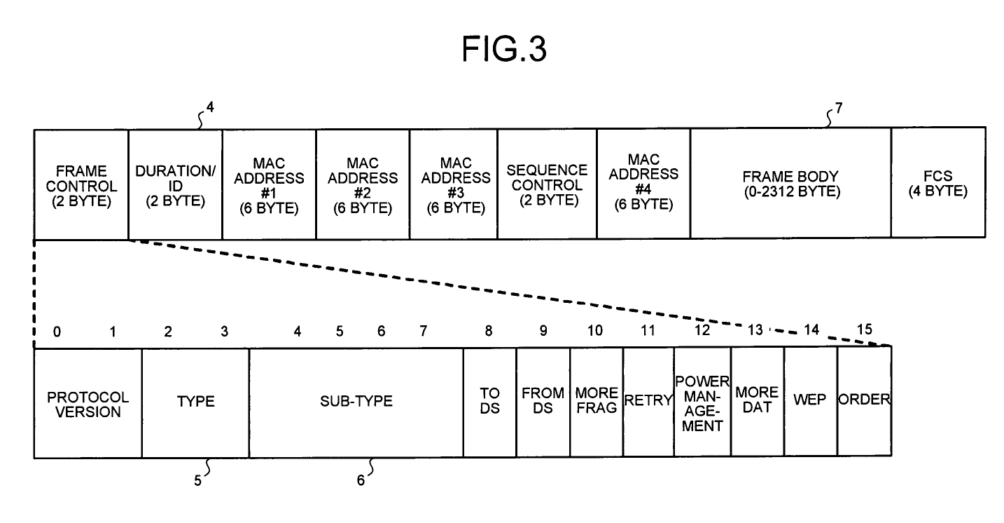

The operation of the wireless communication system according to the first embodiment will be explained with reference to the drawings, taking an example in which there are the wireless base station (AP) 2-A as the wireless base station (AP) 2, and three wireless terminal stations (STA) 3-A, 3-B, and 3C as the wireless terminal station (STA) 3. FIG. 2 is an example of access control between the wireless base station (AP) 2-A and the wireless terminal stations (STA) 3-A, 3-B, and 3C in the wireless communication system according to the first embodiment. FIG. 3 is a configuration diagram of one example of the configuration of a MAC header in a MAC frame defined in the IEEE 802.11 standard.

In the wireless communication system according to this embodiment, the wireless base station (AP) 2-A sets a set value of duration ID in the MAC frame defined in the IEEE 802.11 standard to α(μs) as a transmission allowable time (t_{STA3-A}) with respect to the wireless terminal station (STA) 3-A. The value of the transmission allowable time set to the duration ID is larger than the standard set value specified in the IEEE 802.11, that is, the sum of a Short Interframe Space and an ACK frame transmission time, so that data frame can be transmitted from the wireless terminal station (STA) 3 to the wireless base station (AP) 2. The same applies to the values of other duration IDs. The upper limit of the transmission allowable time is set to 32767. This is described in Table 3 of the duration ID under 7.1.3.2 in the IEEE 802.11 standard (“part 11: wireless LAN medium access control (MAC) and physical layer (PHY) specification”, 1999).

In these transmission control frames, a network allocation vector (NAV) value is set, which is carrier sense information calculated from the transmission allowable time. That is, when transmitting the information specifying the wireless terminal station (STA) 3 that allows transmission of the data frame, a MAC Address of the wireless terminal station (STA) 3 is given to a MAC header address area, and hence, the corresponding wireless terminal station (STA) 3 can be automatically specified. Therefore, when a destination MAC Address of a reception frame is the MAC Address of the own station, the wireless terminal station (STA) 3 can perform transmission thereafter. On the contrary, when other wireless terminal stations (STA) 3 receive a reception frame addressed to a MAC Address of another station, the other wireless terminal stations (STA) 3 do not perform transmission, and only update the transmission allowable time by referring to the duration ID.

For example, in the MAC header configuration of the MAC frame shown in FIG. 3, there are four addresses in the MAC Address field, and how to use the four addresses will be explained below. That is, when “ToDS=0, FroMD=1”, the destination address is set to MAC Address #3. When “ToDS=1, FroMD=1”, the destination address is set to MAC Address #3.

The transmission allowable time in the present invention is a specified time serving as the transmission allowable time, during which two-way transmission of the frame is possible between the own wireless base station and a wireless terminal station accommodated in the own wireless base station, as well as a reservation time for a wireless channel used for the frame transmission between the own wireless base station and the wireless terminal station.

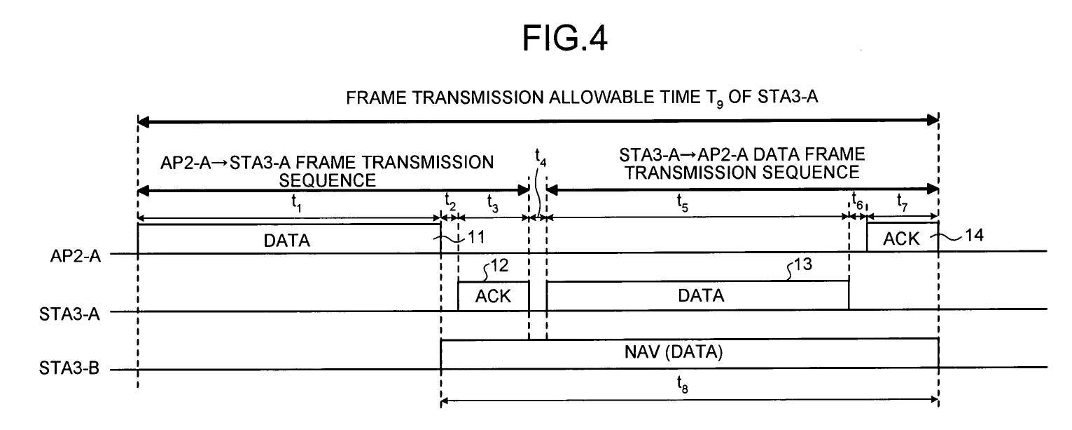

The transmission allowable time in the present invention will be specifically explained by way of examples. An example in which normal wireless communication is performed without using a request to send (RTS)/clear to send (CTS) frame is shown in FIG. 4. FIG. 4 depicts transmission allowable time t₉ when the wireless base station (AP) 2-A sends transmission permission to the wireless terminal station (STA) 3-A. In this case, the transmission allowable time t₉ is the time since the wireless base station (AP) 2-A has transmitted a data frame 11 in which the transmission allowable time t₉ is indicated until the wireless terminal station (STA) 3-A transmits a data frame 13 and receives ACK 14 thereof.

Specifically, in this case, the transmission allowable time t₉ includes the time corresponding to “frame transmission sequence from the wireless base station (AP) 2-A to the wireless terminal station (STA) 3-A”, the time corresponding to “data frame transmission sequence from the wireless terminal station (STA) 3-A to the wireless base station (AP) 2-A”, and the SIFS.

That is, the transmission allowable time t₉ shown in FIG. 4 is total sum of transmission time t₁ of data frame 11 from the wireless base station (AP) 2-A to the wireless terminal station (STA) 3-A, SIF t₂, transmission time t₃ of ACK 12 from the wireless terminal station (STA) 3-A to the wireless base station (AP) 2-A, SIFS t₄, transmission time t₅ of data frame 13 from the wireless terminal station (STA) 3-A to the wireless base station (AP) 2-A, SIFS t₆, and transmission time t₇ of ACK 14 from the wireless base station (AP) 2-A to the wireless terminal station (STA) 3-A.

The wireless base station (AP) 2-A sets a “NAV” value t₈, which is the carrier sense information calculated based on the transmission allowable time t₉, to a transmission control frame and notifies the wireless terminal station (STA) 3 of this matter. The wireless terminal stations (STA) 3 other than the specified wireless terminal station (STA) 3, to which transmission permission is given, determine that the wireless area is “busy” and do not perform frame transmission, when the set “NAV” value is other than 0. That is, in the time duration specified by the NAV t₈, transmission is inhibited.

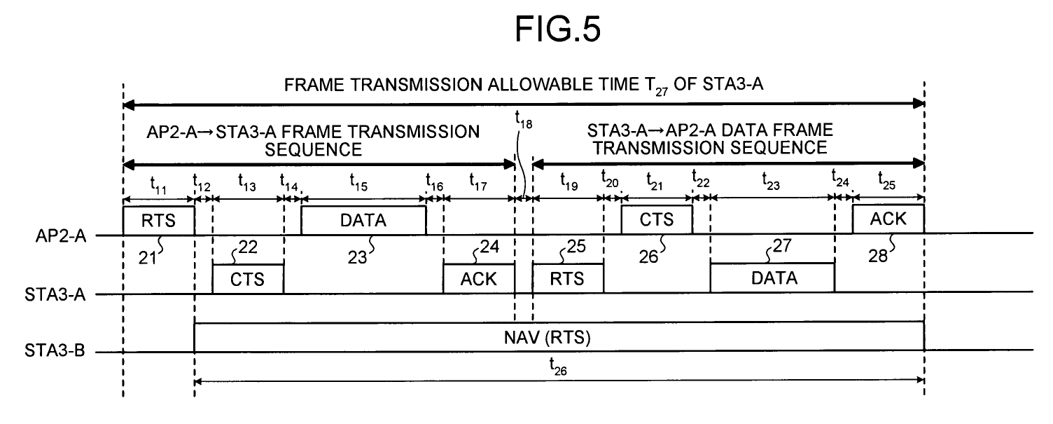

FIG. 5 is an example of using an RTS/CTS frame, which is used when taking into consideration that there is a hidden wireless terminal station (STA) 3. FIG. 5 depicts transmission allowable time t₂₇ when the wireless base station (AP) 2-A gives transmission permission to the wireless terminal station (STA) 3-A. In this case, the transmission allowable time t₂₇ is the time since the wireless base station (AP) 2-A has transmitted an RTS frame 21 until the wireless terminal station (STA) 3-A transmits a data frame and receives ACK 28 thereof.

Specifically, the transmission allowable time t₂₇ total sum of time corresponding to “frame transmission sequence from the wireless base station (AP) 2-A to the wireless terminal station (STA) 3-A”, time corresponding to “data frame sequence from the wireless terminal station (STA) 3-A to the wireless base station (AP) 2-A”, and an interval between the two time durations.

The time corresponding to “frame transmission sequence from the wireless base station (AP) 2-A to the wireless terminal station (STA) 3-A” is total sum of transmission time t₁₁ of RTS frame 21 from the wireless base station (AP) 2-A to the wireless terminal station (STA) 3-A, SIFS t₁₂, transmission time t₁₃ of CTS frame 22 from the wireless terminal station (STA) 3-A to the wireless base station (AP) 2-A, SIFS t₁₄, transmission time t₁₅ of data frame 23 in which the transmission allowable time t₂₇ is indicated from the wireless base station (AP) 2-A to the wireless terminal station (STA) 3-A, SIFS t₁₆, and transmission time t₁₇ of ACK 24 from the wireless terminal station (STA) 3-A to the wireless base station (AP) 2-A.

The time corresponding to “data frame sequence from the wireless terminal station (STA) 3-A to the wireless base station (AP) 2-A” is total sum of transmission time t₁₉ of RTS frame 25 from the wireless terminal station (STA) 3-A to the wireless base station (AP) 2-A, SIFS t₂₀, transmission time t₂₁ of CTS frame 26 from the wireless base station (AP) 2-A to the wireless terminal station (STA) 3-A, SIFS t₂₂, transmission time t₂₃ of data frame 27 from the wireless terminal station (STA) 3-A to the wireless base station (AP) 2-A,-SIFS t₂₄, and transmission time t₂₅ of ACK 28 from the wireless base station (AP) 2-A to the wireless terminal station (STA) 3-A.

Therefore, the transmission allowable time t₂₇ is total sum of the time corresponding to “frame transmission sequence from the wireless base station (AP) 2-A to the wireless terminal station (STA) 3-A”, the time corresponding to “data frame sequence from the wireless terminal station (STA) 3-A to the wireless base station (AP) 2-A”, and SIFS t,₈.

The wireless base station (AP) 2-A sets a “NAV” value t₂₆, which is the carrier sense information calculated based on the transmission allowable time t₂₇, in the transmission control frame and notifies the wireless terminal station (STA) 3 of this matter. The wireless terminal stations (STA) 3 other than the specified wireless terminal station (STA) 3, to which transmission permission is given, determine that the wireless area is “busy” and do not perform frame transmission, when the set “NAV” value is other than 0. That is, in the time duration specified by the NAV t₂₆, transmission is inhibited.

The wireless base station (AP) 2-A then transmits the frame in which the transmission allowable time and the NAV value are set to the respective wireless terminal stations (STA) 3-A, 3-B, and 3-C (steps S1-A, S1-B, and S1-C). In the present invention, the frame is referred to as the transmission control frame. The transmission control frame is transmitted from the wireless base station (AP) 2 to the respective wireless terminal stations (STA) 3 for controlling the timing of the frame transmission by the wireless terminal station (STA) 3. In FIG. 2, it is shown that the steps S1-A, S1-B, and S1-C are performed at the timing different timewise, however, the transmission of the transmission control frame to the respective wireless terminal stations (STA) 3-A, 3-B, and 3-C is performed substantially concurrently. The same applies to the following cases.

The respective wireless terminal stations (STA) 3 receive the transmission control frame and determine whether the transmission control frame is addressed to the own station, that is, whether the transmission allowable time is applied to the own station, based on the destination MAC Address added to the address area in the MAC header. The wireless terminal station (STA) 3-A determines that the transmission control frame is addressed to the own station and the transmission allowable time is applied to the own station based on the destination MAC Address.

Since the own MAC Address is set as the destination MAC Address specifying the wireless terminal station (STA) 3 for which transmission of the data frame is allowed, the wireless terminal station (STA) 3-A can perform data communications with the wireless base station (AP) 2-A, after having received the transmission control frame from the wireless base station (AP) 2-A. That is, data communication with the wireless base station (AP) 2-A becomes possible during the transmission allowable time t_{STA3-A}=α(μs) , and transmission of the data frame from the wireless terminal station (STA) 3-A to the wireless base station (AP) 2-A becomes possible. When there is a data frame to be transmitted, the wireless terminal station (STA) 3-A transmits the data frame to the wireless base station (AP) 2-A (step S2).

The wireless terminal station (STA) 3-A cannot transmit the data frame at a point in time when the transmission allowable time t_{STA3-A}=α(μs) for the wireless terminal station (STA) 3-A has passed.

On the other hand, the wireless terminal stations (STA) 3-B and 3-C determine that the transmission control frame is not addressed to the own station and the transmission allowable time is not applied to the own station based on the destination MAC Address. Since the own MAC Address is not set as the destination MAC Address specifying the wireless terminal station (STA) 3 for which transmission of the data frame is allowed, the wireless terminal stations (STA) 3-B and 3-C suspend data communication with the wireless base station (AP) 2-A during the time set by the duration ID in the transmission control frame, after having received the transmission control frame from the wireless base station (AP) 2-A. In other words, the wireless terminal stations (STA) 3-B and 3-C suspend data communication with the wireless base station (AP) 2-A during the transmission allowable time t_{STA3-A}=α(μs) for the wireless terminal station (STA) 3-A. More specifically, the data communication with the wireless base station (AP) 2-A is suspended only for the time set by the NAV value.

Subsequently, after the transmission allowable time (t_{STA3-A}=α(μs)) for the wireless terminal station (STA) 3-A has passed, as shown in FIG. 2, the wireless base station (AP) 2-A transmits a transmission control frame, in which the value of the duration ID is set to β(μs) as the transmission allowable time (t_{STA3-B}) for the wireless terminal station (STA) 3-B, to the respective wireless terminal stations (STA) 3-A, 3-B, and 3-C (steps S3-A, S3-B, and S3-C).

In the transmission control frame, a NAV value which is the carrier sense information calculated based on the transmission allowable time is also set.

Furthermore, a destination MAC Address specifying the wireless terminal station (STA) 3-B is set in these transmission control frames transmitted at steps S3-A, S3-B, and S3-C, to specify a wireless terminal station for which transmission of the data frame is allowed, so that the wireless base station (AP) 2-A controls data frame transmission from the wireless terminal stations (STA) 3-A, 3-B, and 3-C.

The respective wireless terminal stations (STA) 3 receive the transmission control frame, and determine whether the transmission control frame is addressed to the own station, that is, whether the transmission allowable time is applied to the own station, based on the destination MAC Address. This time, the wireless terminal stations (STA) 3-B determines that the transmission control frame is addressed to the own station and the transmission allowable time is applied to the own station based on the destination MAC Address.

Since the own MAC Address is set as the destination MAC Address specifying the wireless terminal station for which transmission of the data frame is allowed, the wireless terminal station (STA) 3-B can perform data communication with the wireless base station (AP) 2-A, after having received the transmission control frame from the wireless base station (AP) 2-A. That is, data communication with the wireless base station (AP) 2-A becomes possible during the transmission allowable time t_{STA3-B}=β(μs) , and transmission of the data frame from the wireless terminal station (STA) 3-B to the wireless base station (AP) 2-A becomes possible. When there is a data frame to be transmitted, the wireless terminal station (STA) 3-B transmits the data frame to the wireless base station (AP) 2-A (step S4).

The wireless terminal station (STA) 3-B cannot transmit the data frame at a point in time when the transmission allowable time t_{STA3-B}=β(μs) for the wireless terminal station (STA) 3-B has passed.

On the other hand, the wireless terminal stations (STA) 3-A and 3-C determine that the transmission control frame is not addressed to the own station and the transmission allowable time is not applied to the own station based on the destination MAC Address. Since the own MAC Address is not set as the destination MAC Address specifying the wireless terminal station (STA) 3 for which transmission of the data frame is allowed, the wireless terminal stations (STA) 3-A and 3-C suspend data communication with the wireless base station (AP) 2-A during the time set by the duration ID in the transmission control frame, after having received the transmission control frame from the wireless base station (AP) 2-A. In other words, the wireless terminal stations (STA) 3-A and 3-C suspend data communication with the wireless base station (AP) 2-A during the transmission allowable time t_{STA3-B}=β(μs) for the wireless terminal station (STA) 3-A. More specifically, the data communication with the wireless base station (AP) 2-A is suspended during the time set by the NAV value.

Subsequently, after the transmission allowable time (t_{STA3-B}=β(μs)) for the wireless terminal station (STA) 3-B has passed, as shown in FIG. 2, the wireless base station (AP) 2-A transmits a transmission control frame in which the transmission allowable time (t_{STA3-C}) for the wireless terminal station (STA) 3-C, that is, the value of the duration ID is set to γ(μs) with respect to the respective wireless terminal stations (STA) 3-A, 3-B, and 3-C (steps S5-A, S5-B, and S5-C).

In the transmission control frame, a NAV value which is the carrier sense information calculated based on the transmission allowable time is also set.

Furthermore, a destination MAC Address specifying the wireless terminal station (STA) 3-C is set in these transmission control frames transmitted at steps S3-A, S3-B, and S3-C, to specify the wireless terminal station (STA) 3-C, as information specifying the wireless terminal station for which transmission of the data frame is allowed, so that the wireless base station (AP) 2-A controls transmission from the wireless terminal stations (STA).

The respective wireless terminal stations (STA) 3 receive the transmission control frame, and determine whether the transmission control frame is addressed to the own station, that is, whether the transmission allowable time is applied to the own station, based on the destination MAC Address. This time, the wireless terminal stations (STA) 3-C determines that the transmission control frame is addressed to the own station and the transmission allowable time is applied to the own station based on the destination MAC Address.

Since the own MAC Address is set as the destination MAC Address specifying the wireless terminal station for which transmission of the data frame is allowed, the wireless terminal station (STA) 3-C can perform data communication with the wireless base station (AP) 2-A, after having received the transmission control frame from the wireless base station (AP) 2-A. That is, data communication with the wireless base station (AP) 2-A becomes possible during the transmission allowable time t_{STA3-C}=γ(μs) , and transmission of the data frame from the wireless terminal station (STA) 3-C to the wireless base station (AP) 2-A becomes possible. When there is a data frame to be transmitted, the wireless terminal station (STA) 3-C transmits the data frame to the wireless base station (AP) 2-A (step S6).

On the other hand, the wireless terminal stations (STA) 3-A and 3-B determine that the transmission control frame is not addressed to the own station and the transmission allowable time is not applied to the own station based on the destination MAC Address. Since the own MAC Address is not set as the destination MAC Address specifying the wireless terminal station (STA) 3 for which transmission of the data frame is allowed, the wireless terminal stations (STA) 3-A and 3-B suspend data communication with the wireless base station (AP) 2-A during the time set by the duration ID in the transmission control frame, after having received the transmission control frame from the wireless base station (AP) 2-A. In other words, the wireless terminal stations (STA) 3-A and 3-B suspend data communication with the wireless base station (AP) 2-A during the transmission allowable time t_{STA3-B}=γ(μs) for the wireless terminal station (STA) 3-A. More specifically, the data communication with the wireless base station (AP) 2-A is suspended during the time set by the NAV value.

In the series of operation described above, the wireless base station (AP) 2-A monitors data transmitted to the respective wireless terminal stations (STA) 3-A, 3-B, and 3-C for a certain period of time. When there is data to be transmitted, the duration ID and the destination MAC Address specifying the wireless terminal station for which transmission of the data frame is allowed are set in the data, and transmits the transmission control frame together with the data.

On the other hand, after performing monitoring for a certain period of time and when there is no data to be transmitted when the monitoring time is expired, the wireless base station (AP) autonomously sets the value of the duration ID larger than the standard setting specified in the IEEE 802.11, and transmits a dedicated frame for controlling transmission by the wireless terminal stations (STA) to the respective wireless terminal stations (STA) 3.

The transmission control frame transmitted from the wireless base station (AP) 2 for controlling frame transmission from the wireless terminal stations (STA) 3-A, 3-B, and 3-C is not particularly limited as described above. Accordingly, the wireless base station (AP) 2 can transmit a MAC frame specified in the IEEE 802.11 as shown in FIG. 3 as the transmission control frame, or can transmit an individually specified frame as the transmission control frame. When the frame specified in the IEEE 802.11 is used, it can be considered to use a control frame in which Type 5 is Control and Sub-Type 6 is RTS shown in FIG. 2. Furthermore, for example, a frame in which there is no frame body 7 in a frame configuration shown in FIG. 3 can be transmitted, without sticking to the IEEE 802.11.

In the wireless communication system according to the first embodiment, the wireless base station (AP) transmits a transmission control frame to the wireless terminal stations (STA) 3-A, 3-B, and 3-C so that the wireless terminal stations (STA) 3-A, 3-B, and 3-C accommodated in the wireless base station (AP) 2 do not start data frame transmission concurrently. The transmission allowable time serving as the clear-to-send time, during which two-way transmission of the frame is possible between the wireless base station (AP) 2 and the wireless terminal stations (STA) 3-A, 3-B, and 3-C, as well as the reservation time for a wireless channel used for the frame transmission between the wireless base station (AP) 2 and the wireless terminal stations (STA) 3-A, 3-B, and 3-C, and wireless terminal station-specifying information that specifies a wireless terminal station (STA) to which the transmission allowable time is applied is set in the transmission control frame.

Accordingly, only the wireless terminal station (STA) set as the wireless terminal station (STA) to which the transmission allowable time is applied can perform data communication with the wireless base station (AP) 2 by using a predetermined wireless channel, and can transmit a data frame to the wireless base station (AP) 2, during the transmission allowable time.

In the conventional wireless communication system applying only the DCF (CSMA/CA), the NAV time includes only a Short Interframe Space (SIF) and ACKnowledgement (ACK). In the conventional wireless communication system applying only the DCF (CSMA/CA), the wireless terminal stations (STA) can only transmit the ACK with respect to frame transmission from the wireless base station (AP) 2 in the NAV time during which the use of the wireless channel is permitted with respect to a particular wireless terminal station (STA).

The transmission allowable time in the first embodiment serves as the clear-to-send time, during which two-way transmission of the frame is possible between the wireless base station (AP) 2 and the wireless terminal stations (STA) 3-A, 3-B, and 3-C, as well as the reservation time for a wireless channel used for the frame transmission between the wireless base station (AP) 2 and the wireless terminal stations (STA) 3-A, 3-B, and 3-C, with which both the reservation of the wireless channel and permission of frame transmission to the wireless base station (STA) can be performed. The transmission allowable time in the first embodiment includes the transmission time of the data frame from the wireless terminal station (STA) 3 to the wireless base station (AP) 2, in addition to the SIFS and ACK.

In the wireless communication system according to the first embodiment, therefore, the ACK with respect to the frame transmission from the wireless base station (AP) 2 is transmitted in the NAV time during which the use of the wireless channel is permitted with respect to a particular wireless terminal station (STA), and further, the wireless terminal station (STA) can transmit a data frame to the wireless base station (AP) 2.

In certain transmission allowable time, only a particular wireless terminal station (STA) 3 can transmit a data frame to the wireless base station (AP) 2, and other wireless terminal stations (STA) cannot transmit a data frame at the same timing. Furthermore, since the wireless base station (AP) 2 controls frame transmission in the wireless communication system at all times by using the transmission control frame, the frame transmission can be controlled not temporarily but at all times.

Accordingly, frame transmission between the wireless terminal stations (STA) 3 in the wireless communication system can be controlled, and frame collisions between the wireless terminal stations (STA) 3 can be prevented reliably, thereby preventing destruction of a frame due to the occurrence of a frame collision. Even when the wireless base stations (AP) 2 are arranged in a high density, or when the wireless terminal stations (STA) are overcrowded, destruction of the frame can be effectively prevented, to prevent a decrease in the throughput of the whole network, thereby realizing data communication highly reliably.

Second Embodiment

In a second embodiment, an example in which the traffic volume between wireless terminal stations (STA) 3 is controlled in the configuration of the wireless communication system shown in FIG. 1 will be explained.

In the second embodiment, the transmission allowable time for the wireless terminal stations (STA) 3 in the first embodiment is set equal to all wireless terminal stations (STA) 3, that is, set isochronously. The transmission control frame in which the isochronous transmission allowable time is set is transmitted to all the wireless terminal stations (STA) 3.

After having received the transmission control frame transmitted from the wireless base station (AP) 2, only the wireless terminal station (STA) 3 specified as an object to which the transmission allowable time is applied in the transmission control frame can transmit a data frame to the wireless base station (AP) 2 during the transmission allowable time set in the transmission control frame. The isochronous transmission allowable time is also set in the transmission control frame received by the respective wireless terminal stations (STA) 3, in a case that any one of the wireless terminal stations (STA) 3 is specified as an object to which the transmission allowable time is applied.

Accordingly, the time during which the respective wireless terminal stations (STA) 3 can transmit a data frame to the wireless base station (AP) 2 (clear-to-send time of data) becomes equal to each other. By equalizing the clear-to-send time of data among the respective wireless terminal stations (STA) 3, the maximum traffic volume in the respective wireless terminal stations (STA) 3 can be made equal. Accordingly, an occurrence of such a situation that the traffic volume of the respective wireless terminal stations (STA) 3 differs largely, for example, the traffic volume of a part of the wireless terminal stations (STA) 3 increases and the traffic volume of other wireless terminal stations (STA) 3 decreases can be effectively prevented.

According to the wireless communication system in the second embodiment, therefore, inequity in the traffic volume among the wireless terminal stations (STA) 3 can be prevented by controlling the traffic volume to be equal among the wireless base stations (STA) 3. The wireless communication system according to this embodiment can be preferably used in a wireless communication system in which the equity among the wireless terminal stations (STA) 3 is required.

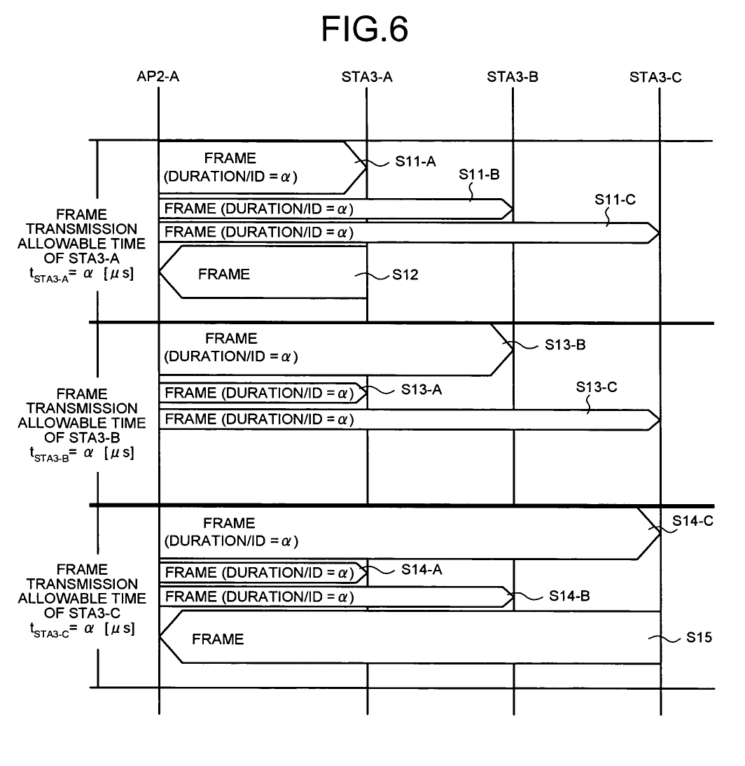

The operation of the wireless communication system according to the second embodiment will be explained with reference to FIG. 6, taking an example in which there are the wireless base station (AP) 2-A as the wireless base station (AP) 2 and three wireless terminal stations (STA) 3-A, 3-B, and 3-C as the wireless terminal station (STA) 3 in the configuration shown in FIG. 1. FIG. 6 is an example of access control between the wireless base station (AP) 2 and the wireless terminal station (STA) 3 when the traffic volume of the respective wireless terminal stations is evenly controlled in the second embodiment.

In the wireless communication system according to the second embodiment, the wireless base station (AP) 2-A transmits a transmission control frame in which the set value of duration ID in the MAC frame defined in the IEEE 802.11 standard is set to α(μs) as the transmission allowable time (t_{STA3-A}) for the wireless terminal station (STA) 3-A, to the respective wireless terminal stations (STA) 3-A, 3-B, and 3-C (steps S11-A, S11-B, and S11-C).

The value of the duration ID is assumed to be larger than the standard set value specified in the IEEE 802.11, that is, the sum of a Short Interframe Space and the ACK frame transmission time, so that data frame can be transmitted from the wireless terminal station (STA) 3 to the wireless base station (AP) 2. The same applies to the values of other duration IDs. In FIG. 6, it is shown that the steps S11-A, S11-B, and S11-C are performed at the timing different timewise, however, the transmission of the transmission control frame to the respective wireless terminal stations (STA) 3-A, 3-B, and 3-C is performed substantially concurrently. The same applies to the following cases.

In the transmission control frame, the NAV value which is the carrier sense information calculated based on the transmission allowable time is also set.

Furthermore, the destination MAC Address specifying the wireless terminal station (STA) 3-A is set in these transmission control frames, as the information specifying a wireless terminal station (STA) 3 for which transmission of the data frame is allowed, so that the wireless base station (AP) 2-A controls data frame transmission from the wireless terminal stations (STA) 3-A, 3-B, and 3-C.

The respective wireless terminal stations (STA) 3 receive the transmission control frame and determine whether the transmission control frame is addressed to the own station, that is, whether the transmission allowable time is applied to the own station, based on the destination MAC Address. The wireless terminal station (STA) 3-A determines that the transmission control frame is addressed to the own station and the transmission allowable time is applied to the own station based on the destination MAC Address.

Since the own MAC Address is set as the destination MAC Address specifying the wireless terminal station (STA) 3 for which transmission of the data frame is allowed, the wireless terminal station (STA) 3-A can perform data communication with the wireless base station (AP) 2-A, after having received the transmission control frame from the wireless base station (AP) 2-A. That is, data communication with the wireless base station (AP) 2-A becomes possible during the transmission allowable time t_{STA3-A}=α(μs) , and transmission of the data frame from the wireless terminal station (STA) 3-A to the wireless base station (AP) 2-A becomes possible. When there is a data frame to be transmitted, the wireless terminal station (STA) 3-A transmits the data frame to the wireless base station (AP) 2-A (step S12).

The wireless terminal station (STA) 3-A cannot transmit the data frame at a point in time when the transmission allowable time t_{STA3-A}=α(μs) for the wireless terminal station (STA) 3-A has passed.

On the other hand, the wireless terminal stations (STA) 3-B and 3-C determine that the transmission control frame is not addressed to the own station and the transmission allowable time is not applied to the own station based on the destination MAC Address. Since the own MAC Address is not set as the destination MAC Address specifying the wireless terminal station (STA) 3 for which transmission of the data frame is allowed, the wireless terminal stations (STA) 3-B and 3-C suspend data communication with the wireless base station (AP) 2-A during the time set by the duration ID in the transmission control frame, after having received the transmission control frame from the wireless base station (AP) 2-A. In other words, the wireless terminal stations (STA) 3-B and 3-C suspend data communication with the wireless base station (AP) 2-A during the transmission allowable time t_{STA3-A}=α(μs) for the wireless terminal station (STA) 3-A. More specifically, the data communication with the wireless base station (AP) 2-A is suspended during the time set by the NAV value.

Subsequently, after the transmission allowable time (t_{STA3-A}=α(μs)) for the wireless terminal station (STA) 3-A has passed, as shown in FIG. 6, the wireless base station (AP) 2-A transmits a transmission control frame, in which the value of the duration ID is set to α(μs) as the transmission allowable time (t_{STA3-B}) for the wireless terminal station (STA) 3-B, to the respective wireless terminal stations (STA) 3-A, 3-B, and 3-C (steps S13-A, S13-B, and S13-C).

In the transmission control frame, a NAV value which is the carrier sense information calculated based on the transmission allowable time is also set. Furthermore, the destination MAC Address specifying the wireless terminal station (STA) 3-B is set as the information specifying a wireless terminal station for which transmission of the data frame is allowed in these transmission control frames.

The respective wireless terminal stations receive the transmission control frame, and determine whether the transmission control frame is addressed to the own station, that is, whether the transmission allowable time is applied to the own station, based on the destination MAC Address. This time, the wireless terminal stations (STA) 3-B determines that the transmission control frame is addressed to the own station and the transmission allowable time is applied to the own station based on the destination MAC Address.

Since the own MAC Address is set as the destination MAC Address specifying the wireless terminal station for which transmission of the data frame is allowed, the wireless terminal station (STA) 3-B can perform data communication with the wireless base station (AP) 2-A, after having received the transmission control frame from the wireless base station (AP) 2-A. That is, data communication with the wireless base station (AP) 2-A becomes possible during the transmission allowable time t_{STA3-B}=α(μs) , and transmission of the data frame from the wireless terminal station (STA) 3-B to the wireless base station (AP) 2-A becomes possible. When there is a data frame to be transmitted, the wireless terminal station (STA) 3-B transmits the data frame to the wireless base station (AP) 2-A. In FIG. 6, a case that there is no data frame to be transmitted is shown.

The wireless terminal station (STA) 3-B cannot transmit the data frame at a point in time when the transmission allowable time t_{STA3-B}=α(μs) for the wireless terminal station (STA) 3-B has passed.

On the other hand, the wireless terminal stations (STA) 3-A and 3-C determine that the transmission control frame is not addressed to the own station and the transmission allowable time is not applied to the own station based on the destination MAC Address. Since the own MAC Address is not set as the destination MAC Address specifying the wireless terminal station (STA) 3 for which transmission of the data frame is allowed, the wireless terminal stations (STA) 3-A and 3-C suspend data communication with the wireless base station (AP) 2-A during the time set by the duration ID in the transmission control frame, after having received the transmission control frame from the wireless base station (AP) 2-A. In other words, the wireless terminal stations (STA) 3-A and 3-C suspend data communication with the wireless base station (AP) 2-A during the transmission allowable time t_{STA3-B}=α(μs) for the wireless terminal station (STA) 3-A. More specifically, the data communication with the wireless base station (AP) 2-A is suspended during the time set by the NAV value.

Subsequently, after the transmission allowable time (t_{STA3-B}=α(μs)) for the wireless terminal station (STA) 3-B has passed, as shown in FIG. 6, the wireless base station (AP) 2-A transmits a transmission control frame, in which the transmission allowable time (t_{STA3-C}) for the wireless terminal station (STA) 3-C in the frame, that is, the value of the duration ID is set to a(ps) as in the case of the wireless terminal stations (STA) 3-A and 3-B, to the respective wireless terminal stations (STA) 3-A, 3-B, and 3-C (steps S14-A, S14-B, and S14-C). In the transmission control frame, a NAV value which is the carrier sense information calculated based on the transmission allowable time is also set. Furthermore, the destination MAC Address specifying the wireless terminal station (STA) 3-C is set as the information specifying a wireless terminal station for which transmission of the data frame is allowed in these transmission control frames.

The respective wireless terminal stations (STA) 3 receive the transmission control frame, and determine whether the transmission control frame is addressed to the own station, that is, whether the transmission allowable time is applied to the own station, based on the destination MAC Address. This time, the wireless terminal stations (STA) 3-C determines that the transmission control frame is addressed to the own station and the transmission allowable time is applied to the own station based on the destination MAC Address.

Since the own MAC Address is set as the destination MAC Address specifying the wireless terminal station for which transmission of the data frame is allowed, the wireless terminal station(STA) 3-C can perform data communication with the wireless base station (AP) 2-A, after having received the transmission control frame from the wireless base station (AP) 2-A. That is, data communication with the wireless base station (AP) 2-A becomes possible during the transmission allowable time t_{STA3-C}=α(μs) , and transmission of the data frame from the wireless terminal station (STA) 3-C to the wireless base station (AP) 2-A becomes possible. When there is a data frame to be transmitted, the wireless terminal station (STA) 3-C transmits the data frame to the wireless base station (AP) 2-A (step S15).

The wireless terminal station (STA) 3-C cannot transmit the data frame at a point in time when the transmission allowable time t_{STA3-C}=γ(μs) for the wireless terminal station (STA) 3-C has passed.

On the other hand, the wireless terminal stations (STA) 3-A and 3-B determine that the transmission control frame is not addressed to the own station and the transmission allowable time is not applied to the own station based on the destination MAC Address. Since the own MAC Address is not set as the destination MAC Address specifying the wireless terminal station (STA) 3 for which transmission of the data frame is allowed, the wireless terminal stations (STA) 3-A and 3-B suspend data communication with the wireless base station (AP) 2-A during the time set by the duration ID in the transmission control frame, after having received the transmission control frame from the wireless base station (AP) 2-A. In other words, the wireless terminal stations (STA) 3-A and 3-B suspend data communication with the wireless base station (AP) 2-A during the transmission allowable time t_{STA3-C}=α(μs) for the wireless terminal station (STA) 3-A. More specifically, the data communication with the wireless base station (AP) 2-A is suspended during the time set by the NAV value.

In the wireless communication system according to the second embodiment, by repetitively performing such operation at all times, the maximum traffic volume among the wireless terminal stations (STA) 3-A, 3-B, and 3-C can be evenly controlled, thereby dissolving the problem of inequity in the traffic volume among wireless terminal stations (STA) 3.

Third Embodiment

In a third embodiment, an example in which in the wireless communication system shown in FIG. 1, the transmission allowable time is set, taking into consideration a request from the wireless base station (STA), will be explained.

In the third embodiment, the respective wireless terminal stations (STA) 3 request desired transmission allowable time, at which allocation of the transmission allowable time to the own wireless terminal station (STA) 3 is desired at the time of transmitting the transmission control frame next time, to the wireless base station (AP) 2. In other words, each of the wireless terminal stations (STA) 3 sets the desired transmission allowable time at the time of transmitting the data frame and transmits the set desired transmission allowable time to the wireless base station (AP) 2. For example, when it is desired the wireless terminal station (STA) to transmit a data frame larger than the normal data frame during the next transmission allowable time, the wireless terminal station (STA) 3 requests the transmission allowable time longer than the normal transmission allowable time. When the data frame to be transmitted during the next transmission allowable time is smaller than the normal data frame, the wireless terminal station (STA) 3 requests the transmission allowable time shorter than the normal transmission allowable time.

The wireless base station (AP) 2 having received the data frame, in which the desired transmission allowable time is set, sets the next transmission allowable timing in the next transmission control frame, taking the desired transmission allowable time into consideration, so that the next clear-to-send time is applied to the wireless terminal station (STA) 3 having transmitted the desired transmission allowable time.

By performing such process, the wireless base station (AP) 2 can set the clear-to-send time adjusted to the data amount held by the wireless terminal station (STA) 3. Accordingly, the data frame transmission based on the actual situation can be realized. For example, occurrence of such situations that all of data cannot be transmitted due to short transmission allowable time as compared with the actual large amount of data to be transmitted and the data transmission is divided, and that the transmission allowable time is set long as compared with the actual data amount to be transmitted, thereby causing useless transmission allowable time can be suppressed.

It is desired that the wireless base station (AP) 2 does not receive the desired transmission allowable time directly as the transmission allowable time, but determines whether the desired transmission allowable time is within a range of a predetermined reference value to accept the desired transmission allowable time. Accordingly, it can be prevented that only a particular wireless terminal station (STA) 3 always obtains long transmission allowable time, and operates advantageously.

In this case, the wireless base station (AP) 2 having received the data frame in which the desired transmission allowable time is set determines whether the desired transmission allowable time set in the data frame is within the predetermined reference value. When the desired transmission allowable time is within the predetermined reference value, the wireless base station (STA) 2 sets the transmission allowable time in the next transmission control frame, which is applied to the wireless terminal station (STA) 3 having transmitted the desired transmission allowable time, and transmits the transmission control frame.

When the desired transmission allowable time is not within the predetermined reference value, that is, the desired transmission allowable time exceeds the predetermined reference value, the wireless base station (STA) 2 sets, for example, the reference value, which is the upper limit of the transmission allowable time, as the clear-to-send time, and transmits the transmission control frame.

The predetermined reference value is, for example, the “reference value=sum total of transmission allowable time/number of wireless terminal stations accommodated in the wireless base station”. When the desired transmission allowable time is equal to or shorter than the reference value calculated in this manner, the wireless base station (STA) 2 sets the transmission allowable time in the next transmission control frame, which is applied to the wireless terminal station (STA) 3 having transmitted the desired transmission allowable time, and transmits the transmission control frame.

When the desired transmission allowable time exceeding the calculated reference value is requested, the wireless base station (STA) 2 determines that unreasonably longer transmission allowable time is requested from the wireless terminal station (STA) 3. In this case, the wireless base station (AP) 2 transmits the transmission control frame in which the reference value, which is the upper limit of the transmission allowable time, is set.

In addition, the wireless base station (AP) 2 notifies, for example, all of the wireless terminal station (STA) 3 of the next desired transmission allowable time. When the sum total of the desired transmission allowable time does not exceed the sum total of the clear-to-send time, even when desired transmission allowable time exceeding the reference value is requested, flexible correspondence is possible, such as allocating the desired transmission allowable time.

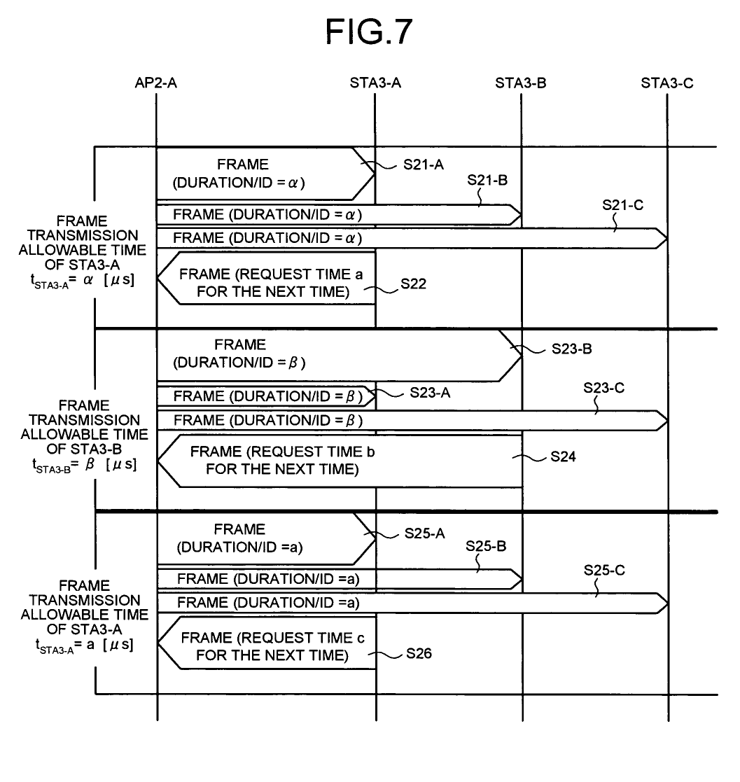

The operation of the wireless communication system according to this embodiment of the present invention will be explained with reference to FIG. 7, taking an example in which there are the wireless base station (AP) 2-A as the wireless base station (AP) 2 and three wireless terminal stations (STA) 3-A, 3-B, and 3-C as the wireless terminal station (STA) 3 in the configuration shown in FIG. 1. FIG. 7 is an example of access control between the wireless base station (AP) 2 and the wireless terminal stations (STA) 3 in this embodiment.

In the wireless communication system in the third embodiment, the wireless base station (AP) 2-A transmits a transmission control frame in which the set value of duration ID in the MAC frame defined in the IEEE 802.11 standard is set to α(μs) as the transmission allowable time (t_{STA3-A}) for the wireless terminal station (STA) 3-A, to the respective wireless terminal stations (STA) 3-A, 3-B, and 3-C (step S21-A, S21-B, and S21-C).

The value of the duration ID is assumed to be larger than the standard set value specified in the IEEE 802.11, that is, the sum of the SIFS and the ACK frame transmission time, so that data frame can be transmitted from the wireless terminal station (STA) 3 to the wireless base station (AP) 2. The same applies to the values of other duration IDs. In FIG. 7, it is shown that the steps S21-A, S21-B, and S21-C are performed at the timing different timewise, however, the transmission of the transmission control frame to the respective wireless terminal stations (STA) 3-A, 3-B, and 3-C is performed substantially concurrently. The same applies to the following cases.

In the transmission control frame, the NAV value, which is the carrier sense information calculated from the transmission allowable time is also set. Furthermore, the destination MAC Address specifying the wireless terminal station (STA) 3-A is set in these transmission control frames, as the information specifying a wireless terminal station (STA) 3 for which transmission of the data frame is allowed.

The respective wireless terminal stations (STA) 3 receive the transmission control frame and determine whether the transmission control frame is addressed to the own station, that is, whether the transmission allowable time is applied to the own station based on the destination MAC Address. The wireless terminal station (STA) 3-A determines that the transmission control frame is addressed to the own station and the transmission allowable time is applied to the own station based on the destination MAC Address.

Since the own MAC Address is set as the destination MAC Address specifying the wireless terminal station (STA) 3 for which transmission of the data frame is allowed, the wireless terminal station (STA) 3-A can perform data communication with the wireless base station (AP) 2-A, after having received the transmission control frame from the wireless base station (AP) 2-A. That is, data communication with the wireless base station (AP) 2-A becomes possible during the transmission allowable time t_{STA3-A}=α(μs) , and transmission of the data frame from the wireless terminal station (STA) 3-A to the wireless base station (AP) 2-A becomes possible. The wireless terminal station (STA) 3-A transmits a data frame to the wireless base station (AP) 2-A (step S22).

At this time, to reserve the next transmission allowable time, the wireless terminal station (STA) 3-A sets in the data frame the transmission allowable time desired to be allocated to the own station at the time of transmission of the next transmission control frame, and transmits the data frame to the wireless base station (AP) 2. The wireless terminal station (STA) 3-A sets NEXT-t_{STA3-A}=α(μs) in the data frame and transmits the data frame.

The wireless base station (AP) 2-A having received the data frame, in which the desired transmission allowable time is set, determines whether the desired transmission allowable time set in the data frame is within the predetermined reference value. When the desired transmission allowable time is within the predetermined reference value, the wireless base station (STA) 2-A sets the next transmission allowable timing in the next transmission control frame, so that the next clear-to-send time is applied to the wireless terminal station (STA) 3-A having transmitted the desired transmission allowable time.

When the desired transmission allowable time exceeds the predetermined reference value, for example, the wireless base station (STA) 2-A sets the reference value, which is the upper limit of the transmission allowable time, in the next transmission control frame, and transmits the transmission control frame.

The wireless terminal station (STA) 3-A cannot transmit a data frame to the wireless base station (AP) 2-A at a point in time when the transmission allowable time t_{STA3-A}=α(μs) for the wireless terminal station (STA) 3-A has passed.

On the other hand, the wireless terminal stations (STA) 3-B and 3-C determine that the transmission control frame is not addressed to the own station and the transmission allowable time is not applied to the own station based on the destination MAC Address. Since the own MAC Address is not set as the destination MAC Address specifying the wireless terminal station (STA) 3 for which transmission of the data frame is allowed, the wireless terminal stations (STA) 3-B and 3-C suspend data communication with the wireless base station (AP) 2-A during the time set by the duration ID in the transmission control frame, after having received the transmission control frame from the wireless base station (AP) 2-A. In other words, the wireless terminal stations (STA) 3-B and 3-C suspend data communication with the wireless base station (AP) 2-A during the transmission allowable time t_{STA3-A}=α(μs) for the wireless terminal station (STA) 3-A. More specifically, the data communication with the wireless base station (AP) 2-A is suspended during the time set by the NAV value.

Subsequently, after the transmission allowable time (t_{STA3-A}=α(μs)) for the wireless terminal station (STA) 3-A has passed, as shown in FIG. 7, the wireless base station (AP) 2-A transmits to the respective wireless terminal stations (STA) 3-A, 3-B, and 3-C a transmission control frame in which the value of the duration ID is set to α(μs) as the transmission allowable time (t_{STA3-B}) for the wireless terminal station (STA) 3-B, as in the case of the wireless terminal station (STA) 3-A (steps S23-A, S23-B, and S23-C). In the transmission control frame, a NAV value which is the carrier sense information calculated based on the transmission allowable time is also set. Furthermore, a destination MAC Address specifying the wireless terminal station (STA) 3-B is set in these transmission control frames as the information specifying a wireless terminal station for which transmission of the data frame is allowed.

The respective wireless terminal stations (STA) 3 receive the transmission control frame, and determine whether the transmission control frame is addressed to the own station, that is, whether the transmission allowable time is applied to the own station, based on the destination MAC Address. This time, the wireless terminal stations (STA) 3-B determines that the transmission control frame is addressed to the own station and the transmission allowable time is applied to the own station based on the destination MAC Address.

Since the own MAC Address is set as the destination MAC Address specifying the wireless terminal station for which transmission of the data frame is allowed, the wireless terminal station (STA) 3-B can perform data communication with the wireless base station (AP) 2-A, after having received the transmission control frame from the wireless base station (AP) 2-A. That is, data communication with the wireless base station (AP) 2-A becomes possible during the transmission allowable time t_{STA3-B}=β(μs) , and transmission of the data frame from the wireless terminal station (STA) 3-B to the wireless base station (AP) 2-A becomes possible. The wireless terminal station (STA) 3-B then transmits the data frame to the wireless base station (AP) 2-A (step S24).

At this time, to reserve the next transmission allowable time, the wireless terminal station (STA) 3-B sets in the data frame the transmission allowable time desired to be allocated to the own station at the time of transmission of the next transmission control frame, and transmits the data frame to the wireless base station (AP) 2. The wireless terminal station (STA) 3-B sets NEXT·t_{STA3-B}=b(μs) in the data frame and transmits the data frame.

The wireless base station (AP) 2-A having received the data frame in which the desired transmission allowable time is set determines whether the desired transmission allowable time set in the data frame is within the predetermined reference value. When the desired transmission allowable time is within the predetermined reference value, the wireless base station (STA) 2-A sets the next transmission allowable timing in the next transmission control frame, so that the next clear-to-send time is applied to the wireless terminal station (STA) 3 having transmitted the desired transmission allowable time.

When the desired transmission allowable time exceeds the predetermined reference value, the wireless base station (STA) 2-A sets the reference value, which is the upper limit of the transmission allowable time, in the next transmission control frame, and transmits the transmission control frame.

The wireless terminal station (STA) 3-B cannot transmit the data frame at a point in time when the transmission allowable time t_{STA3-B}=β(μs) for the wireless terminal station (STA) 3-B has passed.

On the other hand, the wireless terminal stations (STA) 3-A and 3-C determine that the transmission control frame is not addressed to the own station and the transmission allowable time is not applied to the own station based on the destination MAC Address. Since the own MAC Address is not set as the destination MAC Address specifying the wireless terminal station (STA) 3 for which transmission of the data frame is allowed, the wireless terminal stations (STA) 3-A and 3-C suspend data communication with the wireless base station (AP) 2-A during the time set by the duration ID in the transmission control frame, after having received the transmission control frame from the wireless base station (AP) 2-A. In other words, the wireless terminal stations (STA) 3-A and 3-C suspend data communication with the wireless base station (AP) 2-A during the transmission allowable time t_{STA3-B}=β(μs) for the wireless terminal station (STA) 3-A. More specifically, the data communication with the wireless base station (AP) 2-A is suspended during the time set by the NAV value.

Subsequently, after the transmission allowable time (t_{STA3-B}=β(μs)) for the wireless terminal station (STA) 3-B has passed, the wireless base station (AP) 2-A transmits the transmission control frame in which the transmission allowable time (t_{STA3-C}) for the wireless terminal station (STA) 3-C, that is, the value of the duration ID is set to a(μs), which is the desired transmission allowable time requested from the wireless terminal station (STA) 3-A, to the respective wireless terminal stations (STA) 3-A, 3-B, and 3-C (steps S25-A, S25-B, and S25-C). In the transmission control frame, a NAV value which is the carrier sense information calculated based on the transmission allowable time is also set. Furthermore, a destination MAC Address specifying the wireless terminal station (STA) 3-A is set in these transmission control frames as the information specifying a wireless terminal station for which transmission of the data frame is allowed.

The respective wireless terminal stations receive the transmission control frame, and determine whether the transmission control frame is addressed to the own station, that is, whether the transmission allowable time is applied to the own station, based on the destination MAC Address. This time, the wireless terminal stations (STA) 3-A determines that the transmission control frame is addressed to the own station based on the destination MAC Address.

Since the own MAC Address is set as the destination MAC Address specifying the wireless terminal station for which transmission of the data frame is allowed, the wireless terminal station (STA) 3-A can perform data communication with the wireless base station (AP) 2-A, after having received the transmission control frame from the wireless base station (AP) 2-A. That is, data communication with the wireless base station (AP) 2-A becomes possible during the transmission allowable time t_{STA3-A}=a(μs) , and transmission of the data frame from the wireless terminal station (STA) 3-A to the wireless base station (AP) 2-A becomes possible. The wireless terminal station (STA) 3-A transmits the data frame to the wireless base station (AP) 2-A (step S26).

At this time, to reserve the next transmission allowable time, the wireless terminal station (STA) 3-A sets in the data frame the transmission allowable time desired to be allocated to the own station at the time of transmission of the next transmission control frame, and transmits the data frame to the wireless base station (AP) 2. The wireless terminal station (STA) 3-A sets NEXT·t_{STA3-A}=c(μs) in the data frame and transmits the data frame.

The wireless base station (AP) 2-A having received the data frame, in which the desired transmission allowable time is set, determines whether the desired transmission allowable time set in the data frame is within the predetermined reference value. When the desired transmission allowable time is within the predetermined reference value, the wireless base station (STA) 2-A sets the next transmission allowable timing in the next transmission control frame, so that the next clear-to-send time is applied to the wireless terminal station (STA) 3-A having transmitted the desired transmission allowable time.

When the desired transmission allowable time exceeds the predetermined reference value, for example, the wireless base station (STA) 2-A sets the reference value, which is the upper limit of the transmission allowable time, in the next transmission control frame, and transmits the transmission control frame.

The wireless terminal station (STA) 3-A cannot transmit a data frame to the wireless base station (AP) 2-A at a point in time when the transmission allowable time t_{STA3-A}=a(μs) for the wireless terminal station (STA) 3-A has passed.

On the other hand, the wireless terminal stations (STA) 3-B and 3-C determine that the transmission control frame is not addressed to the own station and the transmission allowable time is not applied to the own station based on the destination MAC Address. Since the own MAC Address is not set as the destination MAC Address specifying the wireless terminal station (STA) 3 for which transmission of the data frame is allowed, the wireless terminal stations (STA) 3-B and 3-C suspend data communication with the wireless base station (AP) 2-A during the time set by the duration ID in the transmission control frame, after having received the transmission control frame from the wireless base station (AP) 2-A. In other words, the wireless terminal stations (STA) 3-B and 3-C suspend data communication with the wireless base station (AP) 2-A during the transmission allowable time t_{STA3-B}=a(μs) for the wireless terminal station (STA) 3-A. More specifically, the data communication with the wireless base station (AP) 2-A is suspended during the time set by the NAV value.

In the wireless communication system according to the third embodiment, by repetitively performing such operation at all times, data transmission based on the actual situation of the respective wireless base stations (STA) 3 can be realized.

A case that the desired transmission allowable time is set in the data frame and the data frame is transmitted to the wireless base station (AP) 2 has been explained above. However, the frame for notifying the desired transmission time is not limited to the data frame in the present invention. Therefore, a dedicated frame for notifying the wireless base station (AP) 2 of the desired transmission allowable time can be used. The frame for notifying the desired transmission allowable time can be transmitted by using the MAC frame specified in the IEEE 802.11 shown in FIG. 3 as the transmission control frame, or can be transmitted by using an individually specified frame as the transmission control frame.

Fourth Embodiment

In a fourth embodiment, a case that the wireless base station (AP) 2 performs frame control not only with respect to wireless terminal stations (STA) accommodated in the own wireless terminal station (AP) but also with respect to a wireless terminal station (STA) accommodated in an adjacent wireless base station (AP) will be explained.

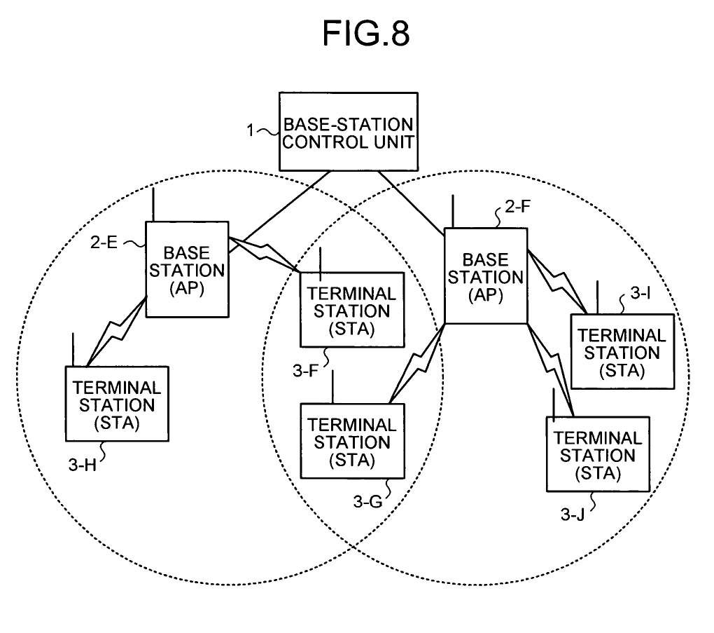

FIG. 8 depicts the wireless communication system according to the fourth embodiment of the present invention. As shown in FIG. 8, the wireless communication system according to the fourth embodiment is a wireless LAN system in conformity with the IEEE 802.11a, b, and g, including a wireless base-station control unit 1, wireless base stations (AP) 2-E, 2-F (hereinafter, also referred to as wireless base station (AP) 2), and wireless terminal stations (STA) 3-F and 3-G (hereinafter, also “wireless terminal station (STA) 3”). The wireless communication system adopts the Distributed Coordination Function (DCF) method and the Virtual Carrier Sense (VCS) control method.

In the wireless communication system shown in FIG. 8, the wireless base station (AP) 2-E accommodates wireless terminal stations (STA) 3-F, and 3-H, and the wireless base station (AP) 2-F accommodates wireless terminal stations (STA) 3-G, 3-I, and 3-J. The wireless terminal stations (STA) 3-F and 3-G are positioned in an area where the wireless communication area of the wireless base station (AP) 2-E and the wireless base station (AP) 2-F overlaps on each other. That is, the wireless terminal station (STA) 3-G is positioned in an interference area in which wireless communication is possible with both the wireless base station (AP) 2-E and the wireless base station (AP) 2-F.

The wireless terminal station (STA) 3-G is not accommodated in the wireless base station (STA) 2-E, however, the wireless base station (STA) 2-E recognizes the wireless terminal station (STA) 3-G. Therefore, the wireless base station (STA) 2-E can transmits the transmission control frame to the wireless terminal station (STA) 3-G, to control the frame transmission of the wireless terminal station (STA) 3-G, as in the case of the wireless terminal stations (STA) 3 accommodated in the own base station.

Likewise, the wireless terminal station (STA) 3-F is not accommodated in the wireless base station (STA) 2-F, however, the wireless base station (STA) 2-F recognizes the wireless terminal station (STA) 3-F. Therefore, the wireless base station (STA) 2-F can transmit the transmission control frame to the wireless terminal station (STA) 3-F, to control the frame transmission of the wireless terminal station (STA) 3-F, as in the case of the wireless terminal stations (STA) 3 accommodated in the own base station.

In this embodiment, the transmission initiative of the transmission allowable time, that is, the transmission right of the transmission control frame specifying an object to which the transmission allowable time is applied is transferred between the adjacent wireless base stations (AP).

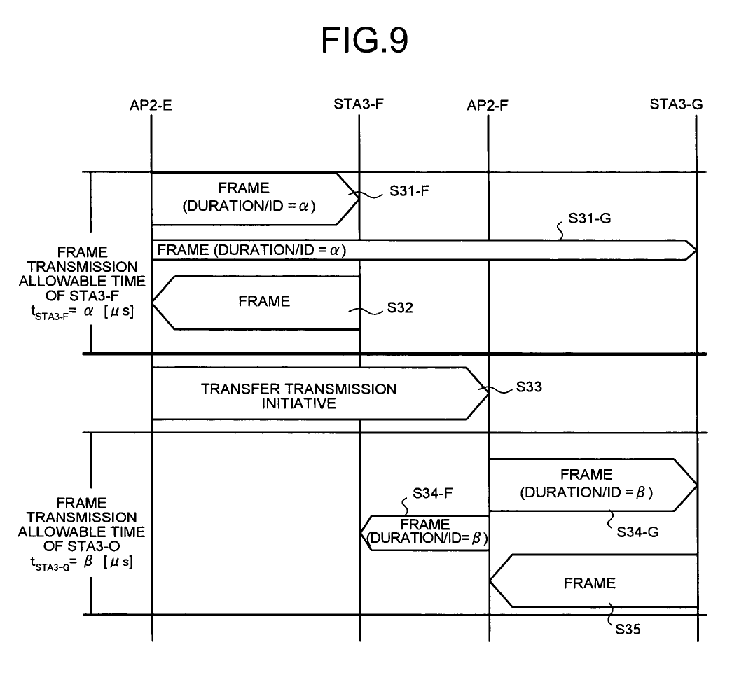

The operation of the wireless communication system in this case will be explained with reference to FIG. 9. FIG. 9 is an example of access control between the wireless base station (AP) 2 and the wireless terminal station (STA) 3 in the fourth embodiment. In FIG. 9, the wireless terminal stations (STA) 3-F and 3-G are particularly shown.

In FIG. 9, the wireless base station (AP) 2-E has the transmission initiative of the transmission control frame, and transmits the transmission control frame, in which the value of the duration ID in the MAC frame is set to α(μs) as the transmission allowable time (t_{STA3-F}) for the wireless terminal station (STA) 3-F, to the respective wireless terminal stations (STA) 3-F and 3-H (step S31-F). At this time, the wireless base station (AP) 2-E transmits the transmission control frame also to the wireless terminal station (STA) 3-G accommodated in the adjacent wireless base station (AP) 2-F (step S31-G).

The value of the duration ID is assumed to be larger than the standard set value specified in the IEEE 802.11, that is, the sum of a SIF and ACK frame transmission time, so that data frame can be transmitted from the wireless terminal station (STA) 3 to the wireless base station (AP) 2. The same applies to the values of other duration IDs. In FIG. 9, it is shown that steps S13-F and S13-G are performed at the timing different timewise, however, the transmission of the transmission control frame to the respective wireless terminal stations (STA) 3-F and 3-G is performed substantially concurrently. The same applies to the following cases.

In the transmission control frame, the NAV value which is the carrier sense information calculated based on the transmission allowable time is also set. Furthermore, the destination MAC Address specifying the wireless terminal station (STA) 3-F is set in these transmission control frames, as the information specifying a wireless terminal station (STA) 3 for which transmission of the data frame is allowed.

The wireless base station (AP) 2-F transmits a transmission control frame, in which the MAC Addresses of the wireless terminal stations (STA) 3-I and 3-J are not set as the destination MAC Address, to the wireless terminal stations (STA) 3-I and 3-J. In this case, the wireless base station (AP) 2-F includes a smart antenna for the wireless terminal stations (STA) 3-I and 3-J and transmits the transmission control frame by using the smart antenna. In this case, therefore, the wireless base station (AP) 2-F can transmit the transmission control frame without having the transmission initiative of the transmission control frame.

The respective wireless terminal stations (STA) 3 receive the transmission control frame and determine whether the transmission control frame is addressed to the own station, that is, whether the transmission allowable time is applied to the own station, based on the destination MAC Address. The wireless terminal station (STA) 3-F determines that the transmission control frame is addressed to the own station and the transmission allowable time is applied to the own station based on the destination MAC Address.

The wireless terminal station (STA) 3-F can perform data communication with the wireless base station (AP) 2-E, after having received the transmission control frame from the wireless base station (AP) 2-E. That is, data communication with the wireless base station (AP) 2-A becomes possible during the transmission allowable time t_{STA3-A}=α(μs) , and transmission of the data frame from the wireless terminal station (STA) 3-F to the wireless base station (AP) 2-E becomes possible. The wireless terminal station (STA) 3-F transmits the data frame to the wireless base station (AP) 2-E (step S32).

The wireless terminal station (STA) 3-F cannot transmit the data frame at a point in time when the transmission allowable time t_{STA3-E}=α(μs) for the wireless terminal station (STA) 3-E has passed.

On the other hand, the wireless terminal stations (STA) 3-H and 3-G determine that the transmission control frame is not addressed to the own station and the transmission allowable time is not applied to the own station based on the destination MAC Address. The wireless terminal stations (STA) 3-H and 3-G suspend data communication with the wireless base station (AP) 2-E during the transmission allowable time t_{STA3-F}=α(μs) for the wireless terminal station (STA) 3-F. More specifically, the data communication with the wireless base station (AP) 2-A is suspended during the time set by the NAV value.

Subsequently, after the transmission allowable time t_{STA3-F}=α(μs) for the wireless terminal station (STA) 3-F has passed, the wireless base station (AP) 2-E transmits a notification frame for transferring the transmission initiative of the transmission control frame, that is, the transmission right of the transmission control frame specifying an object to which the transmission allowable time is applied to the wireless base station (AP) 2-F (step S33).

The wireless base station (AP) 2-F having received the transmission initiative transmits the transmission control frame, in which the value of the duration ID in the MAC frame is set to β(μs) as the transmission allowable time (t_{STA3-G}) for the wireless terminal station (STA) 3-G, to the respective wireless terminal stations (STA) 3-G, 3-I, and 3-J (step S34-G). At this time, the wireless base station (AP) 2-F transmits the transmission control frame also to the wireless terminal station (STA) 3-F accommodated in the adjacent wireless base station (AP) 2-E (step S34-F).

In the transmission control frame, the NAV value which is the carrier sense information calculated based on the transmission allowable time is also set. Furthermore, the destination MAC Address specifying the wireless terminal station (STA) 3-F is set in these transmission control frames, as the information specifying a wireless terminal station (STA) 3 for which transmission of the data frame is allowed.

The wireless base station (AP) 2-E transmits a transmission control frame, in which the MAC Address of the wireless terminal stations (STA) 3-H is not set as the destination MAC Address, to the wireless terminal station (STA) 3-H. In this case, the wireless base station (AP) 2-E includes a smart antenna for the wireless terminal stations (STA) 3-H and transmits the transmission control frame by using the smart antenna. In this case, therefore, the wireless base station (AP) 2-E can transmit the transmission control frame without having the transmission initiative of the transmission control frame.

The respective wireless terminal stations (STA) 3 receive the transmission control frame and determine whether the transmission control frame is addressed to the own station, that is, whether the transmission allowable time is applied to the own station, based on the destination MAC Address. The wireless terminal station (STA) 3-G determines that the transmission control frame is addressed to the own station and the transmission allowable time is applied to the own station based on the destination MAC Address.

The wireless terminal station (STA) 3-G can perform data communication with the wireless base station (AP) 2-E, after having received the transmission control frame from the wireless base station (AP) 2-F. That is, data communication with the wireless base station (AP) 2-F becomes possible during the transmission allowable time t_{STA3-G}=β(μs) , and transmission of the data frame from the wireless terminal station (STA) 3-F to the wireless base station (AP) 2-E becomes possible. The wireless terminal station (STA) 3-F transmits the data frame to the wireless base station (AP) 2-E (step S35).

The wireless terminal station (STA) 3-G cannot transmit the data frame at a point in time when the transmission allowable time t_{STA3-G}=β(μs) has passed.

On the other hand, the wireless terminal stations (STA) 3-I, 3-J, and 3-F determine that the transmission control frame is not addressed to the own station and the transmission allowable time is not applied to the own station based on the destination MAC Address. The wireless terminal stations (STA) 3-I, 3-J, and 3-F suspend data communication with the wireless base station (AP) 2-F during the transmission allowable time t_{STA3-G}=β(μs) for the wireless terminal station (STA) 3-G. More specifically, the data communication with the wireless base station (AP) 2-A is suspended during the time set by the NAV value.

Thus, by transferring the transmission initiative of the transmission control frame between the adjacent wireless base stations (AP), frame control with respect to not only the wireless terminal station (STA) 3 accommodated in the own wireless terminal station (AP) but also the wireless terminal station (STA) accommodated in the adjacent wireless base station (AP) can be performed. Since the notification frame for transferring the transmission initiative is transmitted to the adjacent wireless base station (AP), data collision can be avoided and traffic can be controlled, even in an area where a plurality of wireless base stations (AP) is arranged in a high density and the control areas thereof overlap on each other. Also in this case, therefore, the effects explained in the first to the third embodiments can be obtained.

In this embodiment, the frame for notifying transfer of the transmission initiative of the transmission control frame can be transmitted both by wireless and wired communications. In other words, when the frame is transmitted by wireless, a frame in the IEEE 802.11 format is used, and when the frame is transmitted by wired communication, a frame in the IEEE 802.3 format is used.

Fifth Embodiment

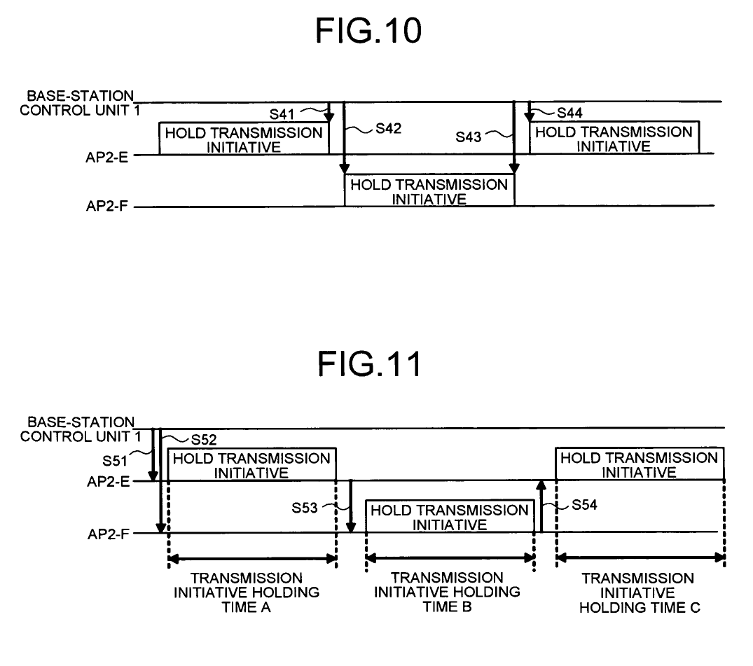

As a fifth embodiment, an embodiment in which the transfer of the transmission initiative of the transmission control frame is performed according to a transfer instruction from a control unit that controls the wireless base stations (AP) 2 will be explained with reference to FIG. 10. FIG. 10 is an example of access control between the wireless base stations (AP) 2 in this embodiment, focusing on a transfer operation of the transmission initiative of the transmission control frame. The configuration of the wireless communication system and the operation relating to transmission of the transmission control frame in the fifth embodiment are the same as those in the fourth embodiment. Therefore, detailed explanation thereof will be omitted, and reference is made to FIG. 8 and the above explanation.

An example in which control in a plurality of wireless base stations (AP) is performed by a wireless base-station control unit 1 will be explained below. In FIG. 8, it is assumed that the wireless base-station control unit 1 tracks the status of wireless base stations (AP) 2-E and 2-F and wireless terminal stations (STA) 3 accommodated in these wireless base stations (AP) 2. It is also assumed that the transmission initiative of the transmission control frame is held by the wireless base station (AP) 2-E.

When the wireless base-station control unit 1 determines to transfer the transmission initiative of the transmission control frame to the wireless base station (AP) 2-F according to the status of the wireless terminal stations (STA) 3, the wireless base-station control unit 1 transmits a frame for notifying the end of the transmission initiative holding time to the wireless base station (AP) 2-E (step S41). The wireless base station (AP) 2-E having received the frame finishes the transmission of the transmission control frame specifying the MAC Address of a wireless terminal station (STA) 3 for which transmission of the data frame is allowed. Subsequently, the wireless base station (AP) 2-E transmits a transmission control frame, in which the MAC Address of a wireless terminal station (STA) 3 for which transmission of the data frame is allowed is not set to the destination MAC Address.

The wireless base-station control unit 1 transmits a frame for notifying the start of the transmission initiative holding time to the wireless base station (AP) 2-F (step S42). The wireless base station (AP) 2-F having received the frame starts transmission of the transmission control frame specifying the MAC Address of the wireless terminal station (STA) 3 for which transmission of the data frame is allowed.

When the wireless base-station control unit 1 determines to transfer the transmission initiative of the transmission control frame to the wireless base station (AP) 2-E according to the status of the wireless terminal stations (STA) 3, the wireless base-station control unit 1 transmits a frame for notifying the end of the transmission initiative holding time to the wireless base station (AP) 2-E (step S43). The wireless base station (AP) 2-F having received the frame finishes the transmission of the transmission control frame specifying the MAC Address of the wireless terminal station (STA) 3 for which transmission of the data frame is allowed. Subsequently, the wireless base station (AP) 2-F transmits a transmission control frame, in which the MAC Address of a wireless terminal station (STA) 3 for which transmission of the data frame is allowed is not set to the destination MAC Address.

The wireless base-station control unit 1 transmits a frame for notifying the start of the transmission initiative holding time to the wireless base station (AP) 2-E (step S44). The wireless base station (AP) 2-E having received the frame starts transmission of the transmission control frame specifying the MAC Address of the wireless terminal station (STA) 3 for which transmission of the data frame is allowed.

In this embodiment, the wireless base-station control unit 1 controls the transmission initiative of the control frame between the adjacent wireless base stations (AP) 2. In other words, since the wireless base-station control unit 1 transmits a frame for notifying the start or the end of the holding time of the transmission initiative of the control frame to the respective wireless base stations (AP) 2, the transmission initiative of the control frame can be transferred as in the fourth embodiment.

Accordingly, even in an interference area where a plurality of wireless base stations (AP) 2 is arranged in a high density and the wireless communication area is overlapped on each other, frame collision can be avoided, and the traffic from the wireless terminal stations (STA) 3 can be controlled. Accordingly, also in the fifth embodiment, the effects explained in the first to the fourth embodiments can be obtained.

The frame used for notifying the start or the end of the holding time of the transmission initiative of the control frame can have a configuration in which notification can be sent both by wireless and wired communications. In other words, when the frame is transmitted by wireless, a frame in the IEEE 802.11 format is used, and when the frame is transmitted by wired communication, a frame in the IEEE 802.3 format is used.

Sixth Embodiment

As a sixth embodiment, another embodiment of the transfer of the transmission initiative of the transmission control frame explained in the fifth embodiment will be explained. In the sixth embodiment, a case that the transfer control is performed by the wireless base-station control unit 1 by notifying the respective wireless base stations (AP) 2 of the holding time of the transmission initiative will be explained with reference to FIG. 11. FIG. 11 is an example of access control between the wireless base stations (AP) 2 in the sixth embodiment, focusing on the transfer operation of the transmission initiative of the transmission control frame. The configuration of the wireless communication system and the operation relating to transmission of the transmission control frame in the sixth embodiment are the same as those in the fourth embodiment. Therefore, detailed explanation thereof will be omitted, and reference is made to FIG. 8 and the above explanation.

An example in which control in a plurality of wireless base stations (AP) is performed by the wireless base-station control unit 1 will be explained below. In FIG. 8, it is assumed that the wireless base-station control unit 1 tracks the status of wireless base stations (AP) 2-E and 2-F and wireless terminal stations (STA) 3 accommodated in these wireless base stations (AP) 2.

When the wireless base-station control unit 1 determines to give the transmission initiative of the transmission control frame to the wireless base station (AP) 2-E according to the status of the wireless terminal stations (STA) 3, the wireless base-station control unit 1 transmits a frame for notifying the time A (hereinafter, as “transmission initiative holding time), during which the transmission initiative of the transmission control frame is allowed, to the wireless base station (AP) 2-E (step S51). The wireless base-station control unit 1 also transmits a frame for notifying the transmission initiative holding time B for the wireless base station (AP) 2-F to the wireless base station (AP) 2-F (step S52).

The wireless base station (AP) 2-E having received the frame starts transmission of a transmission control frame specifying the MAC Address of the wireless terminal station (STA) 3 for which transmission of the data frame is allowed. On the other hand, the wireless base station (AP) 2-F transmits a transmission control frame in which the MAC Address of the wireless terminal station (STA) 3 for which transmission of the data frame is allowed is not set to the destination MAC Address.

Subsequently, after the transmission initiative holding time A for the wireless base station (AP) 2-E has passed, the wireless base station (AP) 2-E suspends transmission of the transmission control frame specifying the MAC Address of the wireless terminal station (STA) 3 for which transmission of the data frame is allowed. The wireless base station (AP) 2-E then transmits a frame for notifying transfer of the transmission initiative to the wireless base station (AP) 2-F (step S53).

The wireless base station (AP) 2-F having received the frame starts transmission of the transmission control frame specifying the MAC Address of the wireless terminal station (STA) 3 for which transmission of the data frame is allowed.

Subsequently, after the transmission initiative holding time B for the wireless base station (AP) 2-F has passed, the wireless base station (AP) 2-F suspends transmission of the transmission control frame specifying the MAC Address of the wireless terminal station (STA) 3 for which transmission of the data frame is allowed. The wireless base station (AP) 2-F then transmits a frame for notifying transfer of the transmission initiative to the wireless base station (AP) 2-E (step S54).

The wireless base station (AP) 2-E having received the frame re-starts transmission of the transmission control frame specifying the MAC Address of the wireless terminal station (STA) 3 for which transmission of the data frame is allowed. On the other hand, the wireless base station (AP) 2-F transmits a transmission control frame in which the MAC Address of the wireless terminal station (STA) 3 for which transmission of the data frame is allowed is not set to the destination MAC Address.

In the sixth embodiment, when the wireless base-station control unit 1 controls the transmission initiative of the control frame between the adjacent wireless base stations (AP) 2, the wireless base-station control unit 1 notifies the respective wireless base stations (AP) 2 of the transmission initiative holding time for each wireless base station. The respective wireless base stations (AP) 2 transfer the transmission initiative to another wireless base station (AP) 2 after the transmission initiative holding time for each wireless base station has passed. In the sixth embodiment, therefore, the transmission initiative of the control frame can be transferred as in the fourth embodiment.

Accordingly, even in the interference area where a plurality of wireless base stations (AP) 2 is arranged in a high density and the wireless communication area is overlapped on each other, frame collision can be avoided and the traffic from the wireless terminal stations (STA) 3 can be controlled. Accordingly, also in the sixth embodiment, the effects explained in the first to the fourth embodiments can be obtained.

The frame used for notifying the transmission initiative holding time of the control frame can have a configuration in which notification can be sent both by wireless and wired communications. In other words, when the frame is transmitted by wireless, a frame in the IEEE 802.11 format is used, and when the frame is transmitted by wired communication, a frame in the IEEE 802.3 format is used.

### INDUSTRIAL APPLICABILITY

As described above, the wireless base station according to the present invention is useful for controlling wireless terminal stations and the traffic in the wireless LAN conforming to the IEEE 802.11, and particularly suitable when the wireless base stations are arranged in a high density.

1-13. (canceled)

14. A wireless base station employing a distributed coordination function, the wireless base station comprising:
a setting unit that sets a specified time serving as a clear-to-send time, during which a two-way frame transmission is possible between a local wireless base station and a wireless terminal station accommodated in the wireless base station, and as a wireless-channel reservation time used for a frame transmission between the wireless base station and the wireless terminal station, and wireless terminal station specifying information for specifying a wireless terminal station to which the specified time is applied, in a transmission control frame for controlling timing of the frame transmission in the wireless terminal station; and
a transmitting unit that transmits the transmission control frame to the wireless terminal station.

15. The wireless base station according to claim 14, wherein the specified time is set in a duration/ID of a media access control frame.

16. The wireless base station according to claim 15, wherein
the specified time is longer than a sum of a transmission time of the transmission control frame, a short interframe space, and an ACK frame transmission time.

17. The wireless base station according to claim 16, wherein ACK frame transmission time for the transmission control frame, transmission time of a data frame from the wireless terminal station, the ACK frame transmission time for the data frame, and the short interframe space between respective frames.

18. The wireless base station according to claim 14, wherein
the transmission control frame is a data frame.

19. The wireless base station according to claim 14, wherein
the transmission control frame is a dedicated frame for controlling timing of the frame transmission in the wireless terminal station.

20. The wireless base station according to claim 14, wherein
the specified time for respective wireless terminal stations accommodated in the local wireless base station is set to same time.

21. The wireless base station according to claim 14, wherein
the specified time is set based on a request for the specified time from the wireless terminal station accommodated in the local wireless base station.

22. The wireless base station according to claim 21, wherein
the requested specified time is set when the specified time requested from the wireless terminal station is equal to or less than a predetermined reference value.

23. The wireless base station according to claim 14, wherein
a right of transmitting the transmission control frame is transferred between the local wireless base station and other wireless base station having an interference area in which the other wireless base station can perform a wireless communication with a wireless terminal station accommodated in the local wireless base station.

24. The wireless base station according to claim 23, wherein
the right of transmitting the transmission control frame is transferred between the local wireless base station and the other wireless base station based on a transfer instruction from a control unit that controls the local wireless base station and the other wireless base station.

25. The wireless base station according to claim 24, wherein
the transfer instruction is information on a time for holding the right of transmitting the transmission control frame.

26. A wireless communication system comprising:
a wireless base station employing a distributed coordination function; and
a plurality of wireless terminal stations accommodated in the wireless base station, wherein
the wireless base station transmits a transmission control frame for controlling timing of frame transmission in the wireless terminal stations,
a specified time serving as a clear-to-send time, during which a two-way frame transmission is possible between a local wireless base station and a wireless terminal station accommodated in the wireless base station, and as a wireless-channel reservation time used for a frame transmission between the wireless base station and the wireless terminal station, and wireless terminal station specifying information for specifying a wireless terminal station to which the specified time is applied is set in the transmission control frame, and
when a local wireless terminal station is a target for applying the specified time, the local wireless terminal station can transmit a frame to the wireless base station, and when the local wireless terminal station is not the target for applying the specified time, the local wireless terminal station suspends a transmission of the frame to the wireless base station.
